(19) United States
(12) Patent Application Publication
(10) Pub. No.: US 2026/0017537 A1
(43) Pub. Date: Jan. 15, 2026

(54) EDGE DEPLOYED DIGITAL TRAINING PLATFORM

(71) Applicant: OBRIZUM GROUP LTD., Cambridge (GB)

(72) Inventors: Chibeza Chintu AGLEY, Cambridge (GB); Olivier Rene M. VAN ACKER, Cambridge (GB)

(21) Appl. No.: 19/266,782

(22) Filed: Jul. 11, 2025

Related U.S. Application Data
(60) Provisional application No. 63/670,019, filed on Jul. 11, 2024.

(51) Int. Cl. G06N 5/022; G09B 5/02

(52) U.S. Cl. CPC G06N 5/022; G09B 5/02

(57) ABSTRACT

The present disclosure includes a training system to present training experiences to users in low-bandwidth, intermittent, or no network connectivity. In some embodiments, such as during periods of low-bandwidth wide area network connectivity or no connectivity for specific parts of the system because of security restrictions, the training system may store media assets and user profile information in local storage and communicate with a remote artificial intelligence model across a wide area network to generate a training experience. In other embodiments, such as during intermittent wide area network connectivity, the training system may retrieve and store media assets, user profile information, and a local artificial intelligence model in local storage during periods when wide area network connection is available. The training system may then generate a training experience from the media assets and the local artificial intelligence model.

### CROSS-REFERENCE TO RELATED APPLICATIONS

This application claims priority to provisional application No. 63/670,019 filed on Jul. 11, 2024, titled “EDGE DEPLOYED DIGITAL TRAINING PLATFORM” which is hereby incorporated by reference herein in its entirety for all purposes.

This application is related to United States patent no. U.S. Pat. No. 11,915,614 B2 filed on Sep. 4, 2020, titled “TRACKING CONCEPTS AND PRESENTING CONTENT IN A LEARNING SYSTEM” which is hereby incorporated by reference herein in its entirety for all purposes.

### BACKGROUND

Online or remote learning and training systems (e.g., educational platforms serving up content and presenting assessments) often utilize wide area network connections (e.g., the Internet) to serve content to users. However, such training systems may not be functional in situations where network connectivity is low or intermittent. Often, training content may be memory intensive, such as content utilizing videos or large files, and communication of such content across a low or intermittent connectivity may be prohibitive to the learning experience. For example, certain content items may be missing or restrictively slow to load.

Additionally, various content platforms, including some training systems, may utilize artificial intelligence (AI) models to provide learning content to users. AI models are often hosted on a server and accessed through a wide area network due to the large memory capacity required to store the AI model. Intermittent or low network connectivity may restrict user communication with an AI model and the subsequent learning experience. Certain AI models may utilize user responses as training data to improve the model. Thus, the effectiveness of the model training and learning system may be diminished where users have restricted communication with the AI model and the AI model is unable to receive some user responses.

Some content providing systems are used in secure environments where sensitive information (e.g., content) cannot leave the area where it is used and/or created. Although there may still be connectivity to the platform online for basic functionality (e.g., authentication), at least some portions of the learning content may be treated as if there is no connectivity to the outside world at all. Such systems may require local content processing and storage that does not utilize network connectivity.

### BRIEF SUMMARY

The present disclosure includes a training system to present training experiences to users in low-bandwidth, intermittent network, or no connectivity. Presenting training experiences may include presenting media training content and receiving user inputs in response to training assessments. In some examples, such as during periods of low-bandwidth wide area network connectivity, the training system may store media assets and user profile information in local storage and communicate with a remote artificial intelligence model across a wide area network to generate a training experience. This may reduce the bandwidth required to generate the training experience since the wide area network connection is only utilized to communicate with the remote artificial intelligence model.

In case of secure environments, the learning content may need to be preprocessed and stored locally for the AI models to operate as designed operate without needing any connectivity to the wide area network. The learning content may be encrypted along various stages (if not the entire stage) of the method, e.g., during communication and storage of the learning content to provide for security of the learning content. This approach safeguards sensitive content against unauthorized access, such as by third parties or users or other instances where the content is not supposed to be accessed.

In other examples, such as during intermittent wide area network connectivity, the training system may retrieve and store the media assets, the user profile information, and a local artificial intelligence model in local storage during periods when wide area network connection is available. The training system may then generate a training experience from the media assets and the artificial intelligence model stored locally, even during periods when the wide area network connection is unavailable.

The training system may then communicate the training experience to a user device across a local area network. In some examples, the training system may record the user training journey (e.g., user inputs and engagement with the training experience) in local storage and re-simulate the training journey with the remote artificial intelligence model during available wide area network connectivity to subsequently update the remote artificial intelligence model and one or more remote computing systems (e.g., cloud computing systems).

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates a first example system in accordance with an embodiment of the disclosure;

FIG. 2 illustrates a second example system in accordance with an embodiment of the disclosure;

FIG. 3 illustrates a third example system in accordance with an embodiment of the disclosure;

FIG. 4 is a flow diagram of example operations for engaging a user with a training experience in low-bandwidth network connectivity in accordance with an embodiment of the disclosure;

FIG. 5 is a flow diagram of example operations for engaging a user with a training experience in intermittent network connectivity in accordance with an embodiment of the disclosure; and

FIG. 6 illustrates a block diagram of an example computer system suitable for use in embodiments disclosed herein in accordance with an embodiment of the disclosure.

### DETAILED DESCRIPTION

Online or remote training systems often require a wide area network connection to access training content and/or artificial intelligence models that are stored remotely (“remote training content” and “remote artificial intelligence models”) and used to provide a training experience (e.g., allowing a user to engage with the platform to learn concepts provided by the content). As used herein, the term “remote” is meant to encompass computer resources (e.g., memory) that are stored in a different location from the user's local computer. For example, those resources that are accessed across WiFi rather than those that are accessed via a local area network. Such resources can include cloud hosted computer resources, remote server sources, and the like. Even resources that are in the same geographic location may still be remote if requiring a wide area network connection.

The training systems may be configured to present users with training or learning content (e.g., video, text, images, etc.), present the user tests or assessments, receive user answers to competence checks or assessments, and receive feedback and content recommendations from the user or other sources. The remote training systems may not function or may function poorly in situations where there is a low-bandwidth wide area network connection (e.g., where the speed or volume of network communication is limited) when there is an intermittent wide area network connection (e.g., where the connection may be available during some periods and unavailable during other periods), or in other scenarios where network connectivity may be difficult or expensive or generally where performance separated from network reliance may be desired. In other words, in many instances, training systems require access to a library of content, which is memory intensive, and access to one or more AI models that help to provide the recommendations and user assessments, which are also processing and memory intensive. As such, in instances with low or lagging network connectivity, the user may experience buffering, delays, and lagging performance as the user tries to engage with the content and the training platform.

Additionally, or alternatively, due to security requirements of the training content, it may be infeasible to store the training content outside the area the user is doing their studying. For example, if the content library includes highly sensitive data (e.g., military or security information), the organization's policy may prevent the content from being stored in other locations outside of secure areas.

The present disclosure includes a training system to present training experiences to users in low or no network environments, such as those with low-bandwidth, intermittent, or no network connectivity. Presenting training experiences may include presenting media training content (e.g., videos, documents, images, and other content) and receiving user inputs in response to training assessments (e.g., user responses to questions about the content). In some examples, such as during periods of low-bandwidth wide area network connectivity, the training system may store media assets and user profile information (which may be anonymized) in local storage and communicate with a remote artificial intelligence model across a wide area network to generate a training experience.

This may keep sensitive content secure or otherwise limited access and may reduce the bandwidth required to generate the training experience since the wide area network connection is only utilized to communicate with the remote artificial intelligence model. In some examples, the training system may pseudonymize, anonymize, and/or otherwise obfuscate all data (e.g., user information, content information, or the like) communicated via wide area network connection with the remote artificial intelligence model. In other examples, such as during intermittent wide area network connectivity, the training system may retrieve and store media assets, user profile information, and a local artificial intelligence model in local storage during periods when wide area network connection is available. The training system may then generate a training experience from the media assets and the local artificial intelligence model stored locally, even during periods when the wide area network connection is unavailable or cannot be accessed because of security reasons.

The training system may then communicate the training experience to a user device across a local area network or other direct connection, such as a hardwired connection, but one that is not connected to a remote compute resource. In some examples, the training system may record the user training journey or AI journey (e.g., user inputs and engagement with the training experience and/or platform) in local storage (either on the user's own device or on a local device coupled to the user device) and re-simulate the training journey with the remote artificial intelligence model (e.g., a cloud-based artificial intelligence model) during available wide area network connectivity or other connection to a remote compute resource to subsequently update the remote artificial intelligence model and one or more remote computing systems. That is, as the user utilizes the platform in the first environment, the inputs and other data associated with the platform during the user's engagement, are saved and used to recreate or replicate the user's experience after the fact in a second environment (e.g., cloud compute).

The training system may be accessible by existing operator systems and applications (e.g., computer systems) such that the training system may easily scale for personal or commercial use. The training system may function as a standalone system or be integrated statically or dynamically into existing software and systems. For example, various modules may be embedded in a website or implemented as a module within a mobile application or software system. It should be noted that although various examples are discussed with respect to training or leaning systems, the techniques are applicable to content providing systems and other AI systems requiring communication with a network for full operation. As such, the discussion of any particular example is meant to be illustrative rather than limiting.

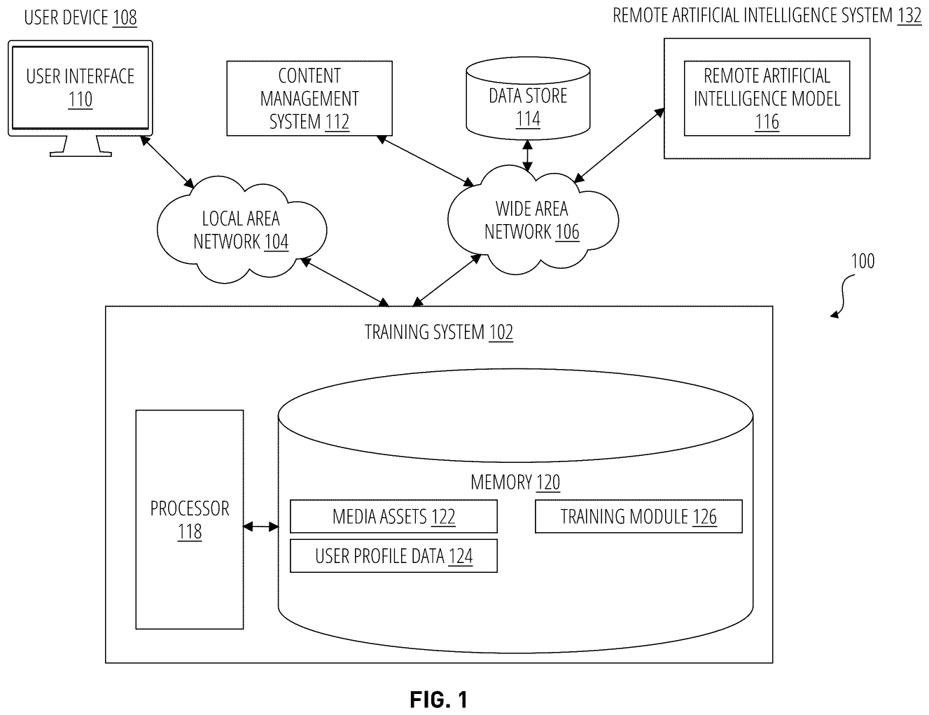

Various embodiments of the present disclosure will be explained below in detail with reference to the accompanying drawings. Other embodiments may be utilized, and structural, logical, and electrical changes may be made without departing from the scope of the present disclosure. Turning now to the drawings, FIG. 1 illustrates a first example system 100 in accordance with an embodiment of the disclosure. For example, the example system can provide a training experience to a user device during periods of low-bandwidth wide area network connectivity. The system includes a user device 108, content management system 112, data store 114, remote artificial intelligence system 132, and remote artificial intelligence model 116 in communication with a training system 102, where the training system 102 engages users with a training experience. The training system 102 is accessible by users through a user interface 110 on user device 108, e.g., through a mobile application or virtual reality application. In some embodiments, the training system 102 may be in communication with one or more user devices 108, one or more content management systems 112, one or more data stores 114, one or more remote artificial intelligence systems 132, and/or one or more remote artificial intelligence models 116.

The training system 102 may be implemented by or at a computing device or combinations of computing resources in various embodiments. In various examples, the training system 102 may be implemented by one or more servers, cloud computing resources, and/or other computing devices. The training system 102 may, for example, be incorporated as a module within a mobile application, software application, or a website presented through a web browser (e.g., at a laptop or desktop computer), and the like. As can be appreciated, how and what components of the training system 102 are implemented on which devices may depend on the expected remote network connectivity.

In some examples, the user device 108 may be a device utilized by an end user, such as a trainee or other person that is interacting with the training system 102. For example, user device 108 may be a virtual reality headset or other computing device used by a trainee to access training content provided by the training system 102.

In some examples, the user device 108 may be configured with a unique digital access code, key, and/or such other authorization codes configured to authorize the user device 108. The authorization code may be configured to authorize communication with the training system 102 and/or decrypt encrypted data received from the training system 102. For example, in some embodiments, the training system 102 may only communicate with authorized devices and may restrict communication with unauthorized devices. The user device 108 may communicate the authorization code to the training system 102 to authorize communication with the training system 102. In some examples, authorization for the user device 108 to communicate with and/or access the training system 102 may be remotely disabled in the event that the user device 108 is lost, broken, or otherwise rendered inactive.

The local area network 104 may be implemented using one or more various systems and protocols for communications between computing devices. In various embodiments, the local area network 104 or various portions of the local area network 104 may be implemented using a local area network (LAN) and/or other networks. In addition to traditional data networking protocols, in some embodiments, data may be communicated according to protocols and/or standards including near field communication (NFC), Bluetooth®, cellular connections, and the like.

The wide area network 106 may be implemented using one or more various systems and protocols for communications between computing devices. In various embodiments, the wide area network 106 or various portions of the local area network 106 may be implemented using the internet, a wide area network (WAN), and/or other networks. In addition to traditional data networking protocols, in some embodiments, data may be communicated according to protocols and/or standards including near field communication (NFC), Bluetooth®, cellular connections, and the like. In some situations, the wide area network 106 connection may be low bandwidth, where the speed or volume of communication across the network may be limited.

In various implementations, the user device 108 and/or additional user devices (not shown) may be implemented using any number of computing devices including, but not limited to a computer, a laptop, tablet, mobile phone, smart phone, wearable device (e.g., AR/VR headset, smart watch, smart glasses, or the like), smart speaker, vehicle (e.g., automobile), or appliance. Generally, the user device 108 may include one or more processors, such as a central processing unit (CPU) and/or graphics processing unit (GPU). The user device 108 may perform operations by executing executable instructions (e.g., software) using the processor(s). The user device 108 may communicate with the training system 102 through a local area network 104. Though only one user device 108 is shown in FIG. 1, any number of user devices may be in communication with the training system 102, in various examples.

In various implementations, the training system 102 may be in communication with a content management system 112. Content management system 112 may generate, process, and/or recommend training content. For example, content management system may process multimedia to categorize the files and add the files to the training content corpus. The content management system 112 may interface with the training system 102 to provide training experiences to the training system 102.

In some examples, the content management system 112 may include a knowledge base. The knowledge base may include a graph or other type of relational or linking structure that includes one or more nodes one or more training content items (e.g., documents, videos, images, or the like). In some examples, the one or more nodes of the knowledge base may be connected by weighted edges, where the weight of an edge represents a probability that the two corresponding nodes represent training content items of a same and/or related concept. In some examples, the one or more nodes of the knowledge base may be connected by edges representing an expected path of a training experience. For example, the one or more nodes of the knowledge base may include directed edges directing traversal from a node to subsequent nodes based on an expected order of presentation of training content for a training experience. In some embodiments, the knowledge base disclosed herein is as described in U.S. Pat. No. 11,915,614 B2, which is incorporated herein by reference for all purposes.

The content management system 112 may be configured to generate an adaptive training experience based on the knowledge base. For example, where a user input reflects a low proficiency with a training content item, the content management system 112 may traverse the knowledge base to recommend a second training content item that is related to the same concept, e.g., if the user answers questions regarding concepts in the training content item incorrectly, the system will recommend a second training content item including content for the same concepts for the user to build on their own knowledge base. The training system 102 may communicate with the content management system 112 to receive the knowledge base and/or training experience. Though only one content management system 112 is shown in FIG. 1, any number of content management systems 112 may be in communication with the training system 102 through the wide area network 106, in various examples.

In various implementations, the training system 102 may be in communication with a data store 114. Data store 114 may include memory storage for remote training content and data relevant to the service of training content to users. For example, data store 114 may store various multimedia files available as training content. In some examples, the training content may be processed, encrypted, and stored in the data store 114 based on the knowledge base. For example, the content management system 112 may analyze a multimedia file to determine a concept represented in the content of the multimedia file. The content management system 112 may generate a node in the knowledge base representing the multimedia file based on the concept and store the multimedia file in the data store 114 with reference to the corresponding node of the knowledge base. Data store 114 may also store user profile information, such as user journeys and training history of users engaged with the training system 102. The data store 114 may be distributed across various physical devices or storage systems. Data store 114 may also store remote user profile data for users engaged with the training system 102. For example, user login information may be stored in the data store 114. Though only one data store 114 is shown in FIG. 1, any number of data stores 114 may be in communication with the training system 102 through the wide area network 106, in various examples.

In various implementations, the training system 102 may be in communication with a remote artificial intelligence system 132 hosting a remote artificial intelligence model 116. Remote artificial intelligence system 132 may communicate with the training system 102 to receive user inputs produced during user engagement with a training experience. Remote artificial intelligence system 132 may communicate the user inputs to remote artificial intelligence model 116. The remote artificial intelligence model 116 may generate training content based on the user inputs and/or recommend training content in response to user proficiency levels. For example, the remote artificial intelligence model 116 may analyze user responses to training assessments (e.g., responses to questions on concepts, such as multiple choice answers, textual responses, or the like) and recommend training content that may be beneficial to the user's training experience based on the analysis (e.g., to support improved learning for specific concepts or combinations of concepts, to present new concepts once a desired level of proficiency has been achieved, to present concepts based on an assessed understanding of the user, etc.). For example, as described in U.S. Pat. No. 11,915,614 B2 filed on Sep. 4, 2020, titled “TRACKING CONCEPTS AND PRESENTING CONTENT IN A LEARNING SYSTEM” incorporated herein by reference, the artificial intelligence model 116 may be configured to generate recommendations for training content based on the user's level of understanding related to the training content. As a specific example, the user may be displayed a certain content at a node corresponding to selected contents and based on the user's engagement with the content, the training system will display particular questions to the user. Based on the user's answers to the questions and optionally a confidence indicator of the user's answers (e.g., a user confidence input or a detected confidence value such as the length of time for the user to answer), the system will determine whether the user has mastered the content and then move to another set of concepts or whether the user requires more learning with certain concepts and present more content related to those concepts.

The remote artificial intelligence model 116 may also generate training content from trusted content sources stored in 114 or at other locations, by, for example, creating compilations of content that may be beneficial to the user or by generating user assessments. The remote artificial intelligence model 116 may additionally provide a reference and/or access to source materials of one or more content items of the compilations of content (e.g., via citation or thumbnail), and the remote artificial intelligence model 116 may highlight portions of the compilations of content that differs from the source materials to support transparency and auditability of the generated training content. If the remote artificial intelligence model 116 modifies any part of the source material to generate the training content, the remote artificial intelligence model may provide a probabilistic assessment of accuracy and change to semantic meaning when compared to the source materials. The remote artificial intelligence model 116 may also utilize the user inputs as training data to further train the remote artificial intelligence model 116. Though only one remote artificial intelligence system 132 and remote artificial intelligence model 116 are shown in FIG. 1, any number of remote artificial intelligence systems 132 and remote artificial intelligence models 116 may be in communication with the training system 102 through the wide area network 106, in various examples.

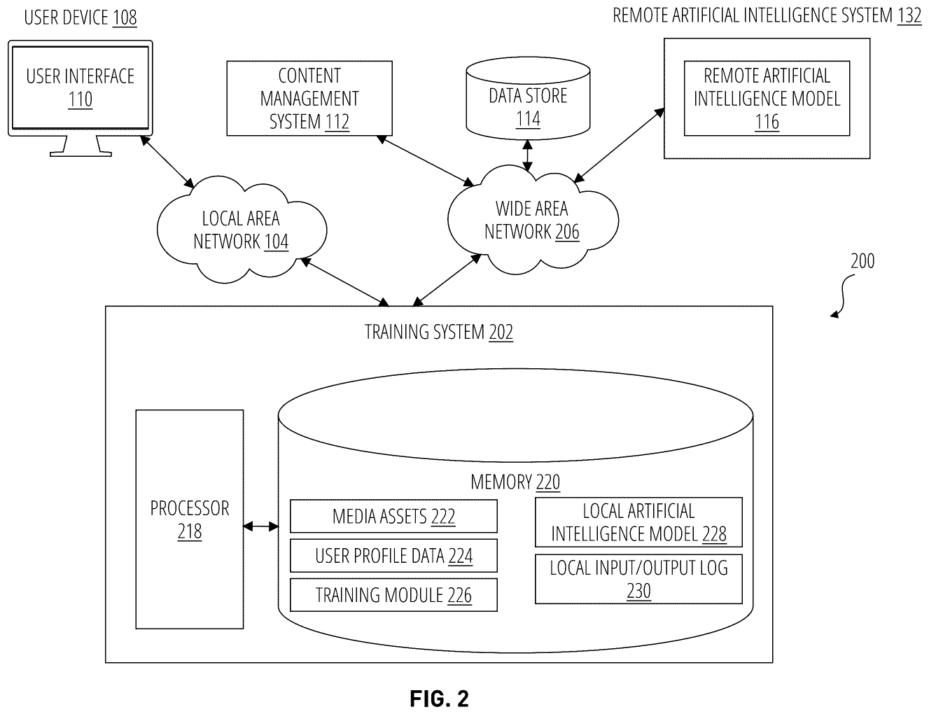

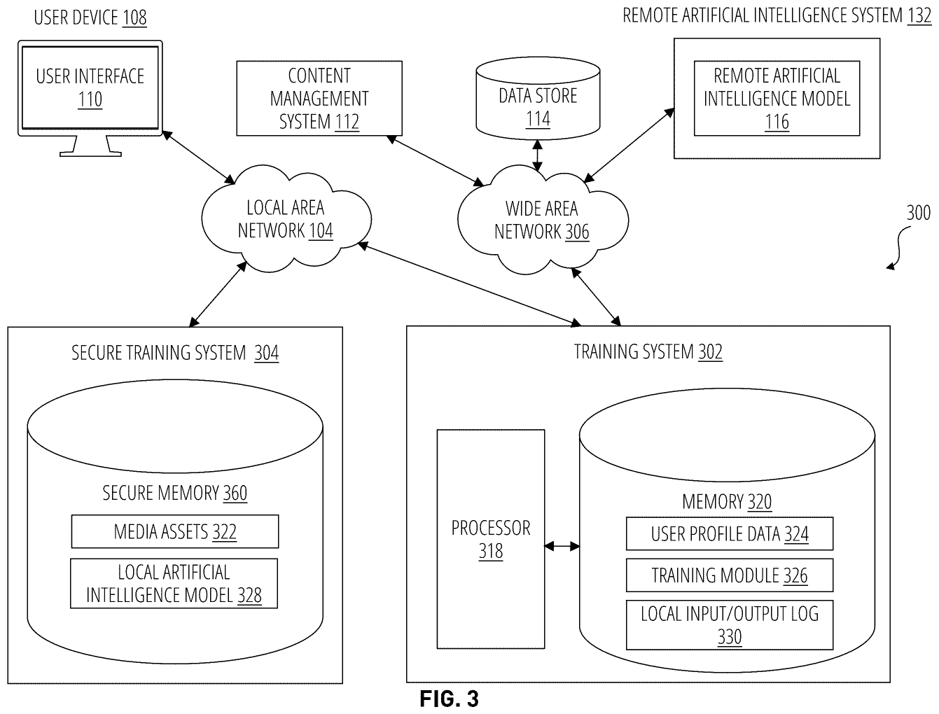

In some examples, the training system 102, the training system 202 described with respect to FIG. 2, and/or the training system 302 described with respect to FIG. 3) may be configured to encrypt data, communicate encrypted data, and/or store encrypted data. For example, the training system 102 may be configured to encrypt all data before communicating the data via the wide area network 106, and the training system 102 may be configured to receive encrypted data through communication via the wide area network 106. The training system 102, the training system 202, the training system 302, and data store 114 may be configured to store encrypted data. For example, the training system 102 may encrypt and store all data in memory 120 as encrypted data. In this manner, the training system 102 may be configured to maintain the security of data by ensuring that only authorized user devices 108 (e.g., authorized laptops, tablets, computers, AR/VR devices, wearable devices, etc.) and/or authorized user profiles are able to access data of the training system 102 and interact with content represented by the data in decrypted form.

FIG. 1 additionally illustrates a schematic diagram of an example training system 102, in accordance with various examples provided herein. In various implementations, the training system 102 may include or utilize one or more hosts or combinations of compute resources, that may be located, for example, at one or more servers, cloud computing platforms, computing clusters, and the like. Generally, the training system 102 is implemented by compute resources including hardware for local storage, such as memory 120, and one or more processors 118. For example, the training system 102 may utilize or include one or more processors, such as a CPU, GPU, TPU, and/or programmable or configurable logic. In some embodiments, various components of the training system 102 may be distributed across various computing resources, such that components of the training system 102 may communicate with one another through the local area network 104 and/or the wide area network 106 or using other communications protocols. For example, in some embodiments, the training system 102 may be implemented as a serverless service, where computing resources for various components of the training system 102 may be located across various computing environments (e.g., cloud platforms) and may be reallocated dynamically and/or automatically according to, for example, resource usage of the training system 102. In various implementations, the training system 102 may be implemented using organizational processing constructs such as functions implemented by worker elements allocated with compute resources, containers, virtual machines, and the like.

The memory 120 may include various instructions for various functions of the training system 102 which, when executed by processor 118, perform various functions of the training system 102. The memory 120 may further store data and/or instructions for retrieving data used by the training system 102. Similar to the processor 118, memory resources utilized by the training system 102 may be distributed across various physical computing devices. In some examples, memory 120 may access instructions and/or data from other devices or locations, and such instructions and/or data may be read into memory 120 to implement the training system 102.

The memory 120 may include or access various types of data or instructions used by the training system 102. Such data and instructions may include media assets 122, user profile data 124, and training module 126, in various examples.

In various examples, the memory 120 may include media assets 122. In some examples, media assets 122 stores training content used to engage a user in a training experience. For example, training content may include multimedia files, such as instructional videos, text files, and audio files. Training content may also include interactive media, such as user assessments and interactive virtual reality or augmented reality media. In some examples, the training content may include an indication of a concept represented in the training content. For example, a multimedia file may reference a corresponding node in the knowledge base that represents the multimedia file and indicates a concept presented in the multimedia file. Media assets 122 may receive the training content from data store 114 through communication across a wide area network 106.

In various examples, the memory 120 may include user profile data 124. In some examples, user profile data 124 stores user profile and authentication information. User authentication information, such as user login information, may be used to authenticate user access to the user's training experience. User authentication information may be stored in fully anonymized or pseudonymized form such that the training system 102 does not store identifiable user information. User profile information may include user journeys, such as user progress in training courses and training courses completed by the user, user assessment data, such as statistics regarding user assessment scores, and other user data relevant to the training experience. User profile and authentication information may be received from data store 114 through communication across a wide area network 106 and/or from user device 108 through communication across a local area network 104. Training module 126 may generate or update user profile and authentication information in response to user inputs received from a user device 108 through communication across a local area network 104.

In various examples, the memory 120 may include instructions for training module 126. Instructions for training module 126 may, when executed by processor 118, generate and engage a user with a training experience. The training experience may be tailored to individual users and may incorporate training content received from media assets 122 and user authentication and profile data received from user profile data 124. The training module 126 may receive user inputs from a user device 108 in response to the training experience and may communicate the user inputs across a wide area network 106 to the remote artificial intelligence system 132 hosting the remote artificial intelligence model 116, where the remote artificial intelligence model 116 may generate training content or content recommendations in response and communicate the content or recommendations to the training module 126 across a wide area network.

For example, the training system 102 and/or remote artificial intelligence model 116 may analyze the user profile data 124 of the user based on the knowledge base, user assessment data, metrics related to user interactions with training content (e.g., time spent by the user interacting with training content, searches conducted by the user related to the training content, etc.) to generate training content curated for the user. The training system and/or remote artificial intelligence model may utilize predictive analytics methods and/or insight generation methods to analyze the user profile data 124 for organizational data discovery and AI-powered insight extraction that is securely integrated with the training system 102 and data store 114.

The training module 126 may then incorporate the generated content into the training experience and/or retrieve the recommended training content from media assets 122 and incorporate the recommended content into the training experience. The training module 126 may generate a user interface 110 or receive a user interface 110 generated by a content management system 112 through communication across a wide area network 106, where the user interface 110 is configured to engage a user with the training experience and is communicated to a user device 108 across a local area network 104.

While the data and instructions, such as media assets 122, user profile data 124, and training module 126, are shown in FIG. 1 as being stored at the memory 120, in some examples, the data and instructions may be stored at other memory resources of the training system 102 and/or at locations remote from the training system 102, such as various databases or data stores or data store 114. In such examples, the memory 120 of the training system 102 may include instructions for accessing such data and instructions from remote locations, including, for example, the locations of the data and/or specific queries used to retrieve data for use by the training system 102.

In some examples, training system 102 and user device 108 may be located in a deployment environment where a training experience is to be presented. The deployment environment may be a physical location that may define a connectivity state of the wide area network 106. For example, the deployment environment may be a location with low bandwidth wide area network connectivity, intermittent wide area network connectivity, and/or any other environment where the presentation of a training experience via a wide area network may not be desired. For example, on-site VR training may be conducted in a deployment environment with limited wide area network connectivity, such as a remote field. The training system 102 and VR device may both be located in the field and may communicate through the use of a local area network 104 to circumvent the limited wide area network connectivity. In another example, the deployment environment may be an environment where the cost of communication via wide area network and/or the communication latency of the wide area network is excessively high and/or where faster performance not dependent on network connectivity may be desired.

The components of FIG. 1 are exemplary only. In various examples, the training system 102 may communicate with and/or include additional components and/or functionality not shown in FIG. 1. Although not shown in FIG. 1, the training system 102 may also be in communication with other systems or components. For example, the training system 102 may communicate with additional memory or data storage through a local area network 104 where the data storage stores training platform data such as training content, user profile data and artificial intelligence models. The training system 102 may also communicate with additional user devices across a wide area network 106 to receive training content or user profile and authentication information.

FIG. 2 illustrates a second example system 200 in accordance with an embodiment of the disclosure. For example, the example system can provide a training experience to a user device during intermittent wide area network connectivity. The system includes a user device 108, content management system 112, data store 114, artificial intelligence system 132, and remote artificial intelligence model 116 in communication with a training system 202, where the training system 202 engages users with a training experience. The training system 202 is accessible by users through a user interface 110 on user device 108, e.g., through a mobile application, virtual reality, augmented reality, and/or mixed reality application. In some embodiments, the training system 202 may be in communication with one or more user devices 108, one or more content management systems 112, one or more data stores 114, one or more artificial intelligence systems 132, and/or one or more artificial intelligence models 116.

The training system 202 may be implemented by or at a computing device or combinations of computing resources in various embodiments. In various examples, the training system 202 may be implemented by one or more servers, cloud computing resources, and/or other computing devices. The training system 202 may, for example, be incorporated as a module within a mobile application, software application, or a website presented through a web browser (e.g., at a laptop or desktop computer), and the like.

In some examples, the elements user device 108, user interface 110, local area network 104, content management system 112, data store 114, remote artificial intelligence system 132, and remote artificial intelligence model 116 are the same or substantially similar to the elements as in FIG. 1 and for brevity, the descriptions are not repeated in conjunction with FIG. 2.

The wide area network 206 may be implemented using one or more various systems and protocols for communications between computing devices. In various embodiments, the wide area network 206 or various portions of the local area network 206 may be implemented using the internet, a wide area network (WAN), and/or other networks. In addition to traditional data networking protocols, in some embodiments, data may be communicated according to protocols and/or standards including near field communication (NFC), Bluetooth®, cellular connections, and the like. In some situations, the wide area network 206 connection may be intermittent, where during some periods, connection through the network is available, and during other periods, connection through the network is unavailable.

FIG. 2 additionally illustrates a schematic diagram of an example training system 202, in accordance with various examples provided herein. In various implementations, the training system 202 may include or utilize one or more hosts or combinations of compute resources, that may be located, for example, at one or more servers, cloud computing platforms, computing clusters, and the like. Generally, the training system 202 is implemented by compute resources including hardware for local storage, such as memory 220, and one or more processors 218. For example, the training system 202 may utilize or include one or more processors, such as a CPU, GPU, and/or programmable or configurable logic. In some embodiments, various components of the training system 202 may be distributed across various computing resources, such that components of the training system 202 may communicate with one another through the local area network 104 and/or the wide area network 206 or using other communications protocols. For example, in some embodiments, the training system 202 may be implemented as a serverless service, where computing resources for various components of the training system 202 may be located across various computing environments (e.g., cloud platforms) and may be reallocated dynamically and/or automatically according to, for example, resource usage of the training system 202. In various implementations, the training system 202 may be implemented using organizational processing constructs such as functions implemented by worker elements allocated with compute resources, containers, virtual machines, and the like.

The memory 220 may include various instructions for various functions of the training system 202 which, when executed by processor 218, perform various functions of the training system 202. The memory 220 may further store data and/or instructions for retrieving data used by the training system 202. Similar to the processor 218, memory resources utilized by the training system 202 may be distributed across various physical computing devices. In some examples, memory 220 may access instructions and/or data from other devices or locations, and such instructions and/or data may be read into memory 220 to implement the training system 202.

The memory 220 may include or access various types of data or instructions used by the training system 202. Such data and instructions may include media assets 222, user profile data 224, training module 226, local artificial intelligence model 228, and input/output log 230, in various examples.

In various examples, the memory 220 may include media assets 222. In some examples, media assets 222 stores training content used to engage a user in a training experience. For example, training content may include multimedia files, such as instructional videos, text files, and audio files. Training content may also include interactive media, such as user assessments and interactive virtual reality media. In some examples, the training content may include an indication of a concept represented in the training content. For example, a multimedia file may reference a corresponding node in the knowledge base that represents the multimedia file and indicates a concept presented in the multimedia file. Media assets 222 may receive the training content from data store 114 through communication across a wide area network 206.

In various examples, the memory 220 may include user profile data 224. In some examples, user profile data 224 stores user profile and authentication information. User authentication information, such as user login information, may be used to authenticate user access to the user's training experience. User profile information may include user journeys, such as user progress in training courses and training courses completed by the user, user assessment data, such as statistics regarding user assessment scores, and other user data relevant to the training experience. User profile and authentication information may be received from data store 114 through communication across a wide area network 206 and/or from user devices 108 through communication across a local area network 104. Training module 226 may generate or update user profile and authentication information in response to user inputs received from a user device 108 through communication across a local area network 104.

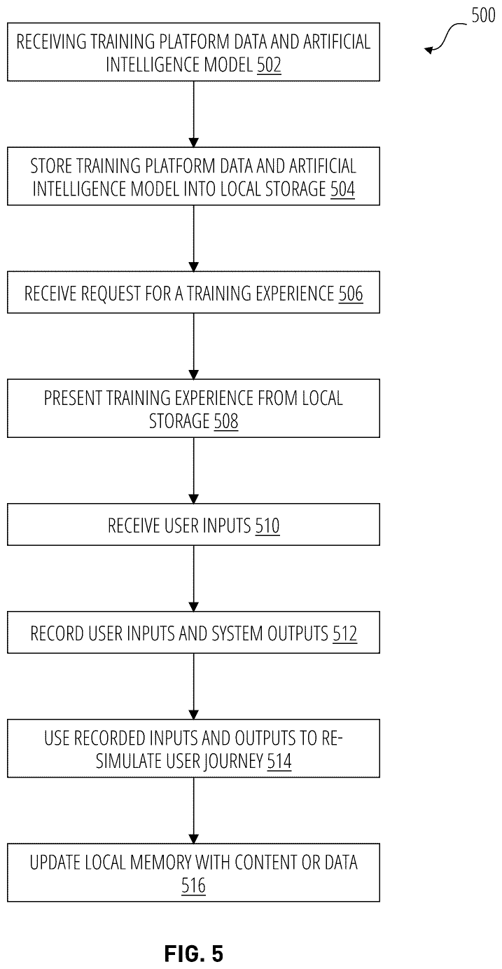

In various examples, the memory 220 may include a local artificial intelligence model 228. In some examples, the local artificial intelligence model 228 may include a copy of the remote artificial intelligence model 116. Local artificial intelligence model 228 may communicate with remote artificial intelligence system 132 hosting remote artificial intelligence model 116 across a wide area network to receive the local artificial intelligence model 228 as a copy of the remote artificial intelligence model 116. For example, the local artificial intelligence model 228 may be a replica of the remote artificial intelligence model 116 and may reflect a current state of the remote artificial intelligence model 116 (e.g., the parameters and/or model weights of the local artificial intelligence model 228 may be a copy of the parameters and/or model weights of the remote artificial intelligence model 116). The training system 202 may utilize the local artificial intelligence model 228 to generate and/or recommend training content. The training system 202 may modify the local artificial intelligence model 228 based on a user input, and the training system 202 may communicate with the remote artificial intelligence system 132 to update the remote artificial intelligence model 116 based on the modifications to the local artificial intelligence model 228. The local artificial intelligence model 228 is described in more detail with respect to method 500 of FIG. 5.

In some examples, the local artificial intelligence model 228 may be a language model (e.g., a large language model) configured to perform natural language processing tasks. For example, the local artificial intelligence model 228 may be configured to conduct natural language search operations configured to conduct intelligent searches based on a natural language search query, a user proficiency of the user related to a concept represented in the search query, the user's progression through a training experience related to the search query, and/or the like.

In various examples, the memory 220 may include a local input/output log 230. The local input/output log 230 may record and store user inputs and training system 202 outputs representative of a user's training journey as the user engages with a training experience. User inputs may be received by the local input/output log 230 from a user device 108 across a local area network 104. Local input/output log 230 may also record outputs generated by the training module 226 and communicated to the user device 108 across a local area network 104. In some examples, the local input/output log 230 may store data indicating the user's progression through the training experience. Based on the user proficiency, the training system 202 may traverse the knowledge base to determine a recommendation of a next training content item. The training system 202 may store data indicating the user proficiency, data indicating the traversal of the knowledge base, and data indicating the recommendation of the training content item in the local input/output log 230.

For example, based on a user input in response to a quiz or assessment, the training system 202 may determine a user proficiency of the user relative to a concept represented in the quiz or assessment. As described herein, a quiz and/or assessment may include multiple choice questions, written or typed short-answer questions, long form open/essay questions, voice-based question and answer combinations, and/or interactive identification exercises (e.g., exercises requesting a user to point out or highlight items, concepts, or other entities in text, images, audio, videos, or VR/AR experiences). In some examples, the content of the quiz and/or assessment may be pre-determined, dynamically determined, or generated by the remote artificial intelligence model 116 and/or the local artificial intelligence model 228 based on the media assets 222. The media assets 222 may include training content with verified accuracy, and as such, the quiz and/or assessment is generated based on accurate media assets 222 that increases the accuracy of the generated content. In some examples, training content generated by the local artificial intelligence model 228 and/or remote artificial intelligence model 116 may be audited by a user. For example, the user interface 110 of the user device 108 may include human-in-the-loop controls configured to allow a user to audit the accuracy of artificial intelligence generated training content and to approve, reject, and/or modify the generated training content. The type of assessment and user input that is evaluated may be varied based on the type of training content and recommendations from the platform. For example, examples of assessments include multiple choice quizzes where the user selects one or more answers as provided, a free form responses where a user inputs a textual or image answer freely in response to a question, or other types of mechanisms to identify a user's understanding of concepts within content. The assessment may include not only the user's answer and how they answered, but also the user's confidence while answering. The confidence information can be detected (e.g., length of time to provide an input, changes to an input, or the like) or provided (e.g., a user input confidence value or a slider to represent the user's confidence in the answer being correct). In any event, the user assessment information may include both user provided data in response to the assessment and/or confidence information detected or provided.

In various examples, the memory 220 may include instructions for training module 226. Instructions for training module 226 may, when executed by processor 218, generate and engage a user with a training experience. The training experience may be tailored to individual users and may incorporate training content received from media assets 222 and user authentication and profile data received from user profile data 224.

The training module 226 may receive user inputs from a user device 108 across a local area network 104 in response to the training experience. During periods when connection through a wide area network 206 is unavailable, the training module 226 may communicate the user inputs to the local artificial intelligence model 228, where the local artificial intelligence model 228 may generate training content or content recommendations in response and communicate the content or recommendations to the training module 226. The training module 226 may then incorporate the generated content into the training experience and/or retrieve the recommended training content from media assets 222 and incorporate the recommended content into the training experience. The training module 226 may generate a user interface 110 or receive a user interface 110 generated by a content management system 112 through communication across a wide area network 206, where the user interface 110 is configured to engage a user with the training experience and is communicated to a user device 108 across a local area network 104.

The training module 226 may communicate the user inputs received from the user device 108 and system outputs generated by the training module 226, e.g., content generated by the local artificial intelligence model 228, to the local input/output log 230. During periods when connection through a wide area network 206 is available, the training module 226 may communicate the user inputs and system outputs to the remote artificial intelligence system 132 hosting the remote artificial intelligence model 116, content management system 112, data store 114, or other remote computing systems across a wide area network 206 to re-simulate the user content journey with the remote artificial intelligence model 116.

While the data, analytics, and/or instructions, such as media assets 222, user profile data 224, training module 226, local artificial intelligence model 228, and local input/output log 230, are shown in FIG. 2 as being stored at the memory 220, in some examples, the data and instructions may be stored at other memory resources of the training system 202 and/or at locations remote from the training system 202, such as various databases or data stores or data store 114. In such examples, the memory 220 of the training system 202 may include instructions for accessing such data and instructions from remote locations, including, for example, the locations of the data and/or specific queries used to retrieve data for use by the training system 202.

In some examples, training system 202 and user device 108 may be located in a deployment environment where a training experience is to be presented. The deployment environment may be a physical location with low bandwidth wide area network connectivity, intermittent wide area network connectivity, and/or any other environment where the presentation of a training experience via a wide area network may not be desired. For example, on-site VR training may be conducted in a deployment environment with limited wide area network connectivity, such as a remote field. The training system 202 and VR device may both be located in the field and may communicate through the use of a local area network 104 to circumvent the limited wide area network connectivity. In another example, the deployment environment may be an environment where the cost of communication via wide area network and/or the communication latency of the wide area network is excessively high and/or where faster performance not dependent on network connectivity may be desired. In some examples, the training system 202 may be configured to automatically switch to access and utilize data stored locally in memory 220 when certain conditions are met (e.g., when wide area network 206 speed or bandwidth drops below a certain threshold). In such examples, the training system 202 may be configured to automatically switch to access and utilize remote data and systems (e.g., the content management system 112, data store 114, and/or remote artificial intelligence system 132) via the wide area network 206 during periods of available wide area network 206 connectivity.

In some examples, when the training module 202 switches to local access or remote access, the training system 202 may cause the user interface 110 of the user device 108 to display a notification notifying the user of the switch and a reason for the switch (e.g. the user interface be configured to display a message, such as, “switching to local access as bandwidth is below threshold”), and a symbol or specified color code of the user interface 110 components may be displayed in the user interface 110 to indicate the switch to local access or remote access.

The components of FIG. 2 are exemplary only. In various examples, the training system 202 may communicate with and/or include additional components and/or functionality not shown in FIG. 2. Although not shown in FIG. 2, the training system 202 may also be in communication with other systems or components. For example, the training system 202 may communicate with additional memory or data storage through a local area network 104 where the data storage stores training platform data such as training content, user profile data and artificial intelligence models. The training system 202 may also communicate with additional user devices across a wide area network 206 to receive training content or user profile and authentication information.

FIG. 3 illustrates a third example system 300 in accordance with an embodiment of the disclosure. For example, the example system can provide a training experience to a user device where part of the system has no connectivity to the wide area network. The system includes a user device 108, content management system 112, data store 114, artificial intelligence system 132, and remote artificial intelligence model 116 in communication with a training system 302, where the training system 302 engages users with a training experience. Additionally, the system 300 includes a secure training system 304, only connected to the local area network 104 and not connected to the wide area network 306. The training system 302 and the secure training system are accessible by users through a user interface 110 on user device 108, e.g., through a mobile application or virtual reality application. In some embodiments, the training system 302 and secure training system 304 may be in communication with one or more user devices 108, one or more content management systems 112, one or more data stores 114, one or more artificial intelligence systems 132, and/or one or more artificial intelligence models 116.

The training system 302 and secure training system 304 may be implemented by or at a computing device or combinations of computing resources in various embodiments. In various examples, the training system 302 and secure training system 304 may be implemented by one or more servers, cloud computing resources, and/or other computing devices. The training system 302 and secure training system 304 may, for example, be incorporated as a module within a mobile application, software application, or a website presented through a web browser (e.g., at a laptop or desktop computer), and the like.

In some examples, the elements user device 108, user interface 110, local area network 104, content management system 112, data store 114, remote artificial intelligence system 132, and remote artificial intelligence model 116 are the same or substantially similar to the elements as in FIG. 1 and for brevity, the descriptions are not repeated in conjunction with FIG. 3.

The wide area network 306 may be implemented using one or more various systems and protocols for communications between computing devices. In various embodiments, the wide area network 306 or various portions of the local area network 306 may be implemented using the internet, a wide area network (WAN), and/or other networks. In addition to traditional data networking protocols, in some embodiments, data may be communicated according to protocols and/or standards including near field communication (NFC), Bluetooth®, cellular connections, and the like.

FIG. 3 additionally illustrates a schematic diagram of an example training system 302 and an example secure training system 304, in accordance with various examples provided herein. In various implementations, the training system 302 and secure training system 304 may include or utilize one or more hosts or combinations of compute resources, that may be located, for example, at one or more servers, cloud computing platforms, computing clusters, and the like. Generally, the training system 302 and secure training system 304 are implemented by compute resources including hardware for local storage, such as memory 320, and one or more processors 318. For example, the training system 302 and secure training system 304 may utilize or include one or more processors, such as a CPU, GPU, and/or programmable or configurable logic. In some embodiments, various components of the training system 302 or secure training system 304 may be distributed across various computing resources, such that components of the training system 302 or secure training system 304 may communicate with one another through the local area network 104 and/or the wide area network 306 or using other communications protocols. For example, in some embodiments, the training system 302 or secure training system 304 may be implemented as a serverless service, where computing resources for various components of the training system 302 or secure training system 304 may be located across various computing environments (e.g., cloud platforms) and may be reallocated dynamically and/or automatically according to, for example, resource usage of the training system 302 or secure training system 304. In various implementations, the training system 302 or secure training system 304 may be implemented using organizational processing constructs such as functions implemented by worker elements allocated with compute resources, containers, virtual machines, and the like.

In some examples, the training system 302 may be in communication with the content management system 112, data store 114, and remote artificial intelligence system 132 via the global wide area network 306, and the training system 302 may be in communication with the user device 108 and secure training system 304 via the local area network 104. The secure training system 304 may only be in communication with the user device 108 and the training system 302 via the local area network 104 and may not be in communication with any systems or data stores across the global wide area network 306.

The memory 320 and secure memory 360 may include various instructions for various functions of the training system 302 and secure training system 304 which, when executed by processor 318, perform various functions of the training system 302 and secure training system 304. The memory 320 and secure memory 360 may further store data and/or instructions for retrieving data used by the training system 302 and secure training system 304. Similar to the processor 318, memory resources utilized by the training system 302 and secure training system 304 may be distributed across various physical computing devices. In some examples, memory 320 or secure memory 360 may access instructions and/or data from other devices or locations, and such instructions and/or data may be read into memory 320 or secure memory 360 to implement the training system 302 or secure training system 304.

The secure memory 360 may include or access various types of data or instructions used by the secure training system 304. Such data and instructions may include media assets 322 and local artificial intelligence model 328. Certain sensitive data may require secure storage in a secure environment where such sensitive data may not be communicated or transferred outside of the secure environment. Data and instructions stored in secure memory 360 may not be accessible via the global wide area network 306 that may facilitate the secure storage of any data or instructions stored in secure memory 360.

In various examples, the secure memory 360 may include media assets 322. In some examples, media assets 322 stores training content used to engage a user in a training experience. For example, training content may include multimedia files, such as instructional videos, text files, and audio files. Training content may also include interactive media, such as user assessments and interactive virtual reality media. In some examples, the training content may include an indication of a concept represented in the training content. For example, a multimedia file may reference a corresponding node in the knowledge base that represents the multimedia file and indicates a concept presented in the multimedia file. Media assets 322 may receive the training content from the training system 302 through communication via the local area network 104.

In various examples, the memory 320 may include a local artificial intelligence model 328. In some examples, the local artificial intelligence model 328 may include a copy of the remote artificial intelligence model 116 received from communication with training system 302 via local area network 104.

The memory 320 may include or access various types of data or instructions used by the training system 302. Such data and instructions may include user profile data 324, training module 326, and input/output log 330, in various examples.

In various examples, the memory 320 may include user profile data 324. In some examples, user profile data 324 stores user profile and authentication information. User authentication information, such as user login information, may be used to authenticate user access to the user's training experience. User profile information may include user journeys, such as user progress in training courses and training courses completed by the user, user assessment data, such as statistics regarding user assessment scores, and other user data relevant to the training experience. User profile and authentication information may be received from data store 114 via communication across the global wide area network 306 and/or from user device 108 via communication across a local area network 104. Training module 326 may generate or update user profile and authentication information in response to user inputs received from a user device 108 through communication via the local area network 104.

In various examples, the memory 320 may include a local input/output log 330. The local input/output log 330 may record and store user inputs and training system 302 outputs representative of a user's training journey as the user engages with a training experience. User inputs may be received by the local input/output log 330 from a user device 108 via the local area network 104. Local input/output log 330 may also record outputs generated by the training module 326 and communicated to the user device 108 via the local area network 104.

In various examples, the memory 320 may include instructions for training module 326. Instructions for training module 326 may, when executed by processor 318, generate and engage a user with a training experience. The training experience may be tailored to individual users and may incorporate training content stored in media assets 322 and user authentication and profile data stored in user profile data 324.

The training module 326 may receive user inputs from a user device 108 via the local area network 104 in response to the training experience. The training module 326 may communicate the user inputs to the local artificial intelligence model 328, where the local artificial intelligence model 328 may generate training content or content recommendations in response and communicate the content or recommendations to the training module 326. The training module 326 may then incorporate the generated content into the training experience and/or retrieve the recommended training content from media assets 322 and incorporate the recommended content into the training experience. The training module 326 may generate a user interface 110 or receive a user interface 110 generated by a content management system 112 through communication via the wide area network 306, where the user interface 110 is configured to engage a user with the training experience and is communicated to a user device 108 via the local area network 104.

The training module 326 may communicate the user inputs received from the user device 108 and system outputs generated by the training module 326, e.g., content generated by the local artificial intelligence model 328, to the local input/output log 330. The training module 326 may communicate the user inputs and system outputs to the remote artificial intelligence system 132 hosting the remote artificial intelligence model 116, content management system 112, data store 114, or other remote computing systems via the wide area network 306 to re-simulate the user content journey with the remote artificial intelligence model 116.

While the data and instructions, such as media assets 322, user profile data 324, training module 326, local artificial intelligence model 328, and local input/output log 330, are shown in FIG. 3 as being stored at the memory 320 and secure memory 360, in some examples, the data and instructions may be stored at other memory resources of the training system 302 and secure training system 304 and/or at locations remote from the training system 302 and secure training system 304, such as various databases or data stores or data store 114. In such examples, the memory 320 or secure memory 360 may include instructions for accessing such data and instructions from remote locations, including, for example, the locations of the data and/or specific queries used to retrieve data for use by the training system 302 or secure training system 304.

In some examples, training system 302, secure training system 304, and user device 108 may be located in a secure deployment environment where a training experience is to be presented. The secure deployment environment may be an environment where communication of data via wide area network is restricted for security protection. For example, on-site VR training may be conducted in a secure deployment environment where training experiences and data used within the secure environment are restricted from being communicated outside of the secure environment. The training system 302, secure training system 304, and VR device may both be located in the secure environment and may communicate via the local area network 104 to prevent secure data from being communicated outside of the secure environment.

The components of FIG. 3 are exemplary only. In various examples, the training system 302 and secure training system 304 may communicate with and/or include additional components and/or functionality not shown in FIG. 3. Although not shown in FIG. 3, the training system 302 and secure training system 304 may also be in communication with other systems or components. For example, the training system 302 may communicate with additional memory or data storage through a local area network 104 where the additional memory or data storage may be located in a secure deployment environment.

In some examples, where a training system (e.g., the training system 102, training system 202, and/or training system 302) is connected to a wide area network (e.g., the wide area network 106, wide area network 206, and/or wide area network 306) and/or is communicating data via the wide area network, the training system may cause the user device 108 to display an indication that the training system is connected to the wide area network (e.g., via the user interface 110). For example, the user interface 110 may be configured to display a notification, symbol, icon, color code, and/or the like to notify the user that the training system is currently accessing and/or communicating via the wide area network. In some examples, where the training system is not connected to a wide area network, the training system may similarly cause the user device 108 to display an indication that the training system is not connected to the wide area network.

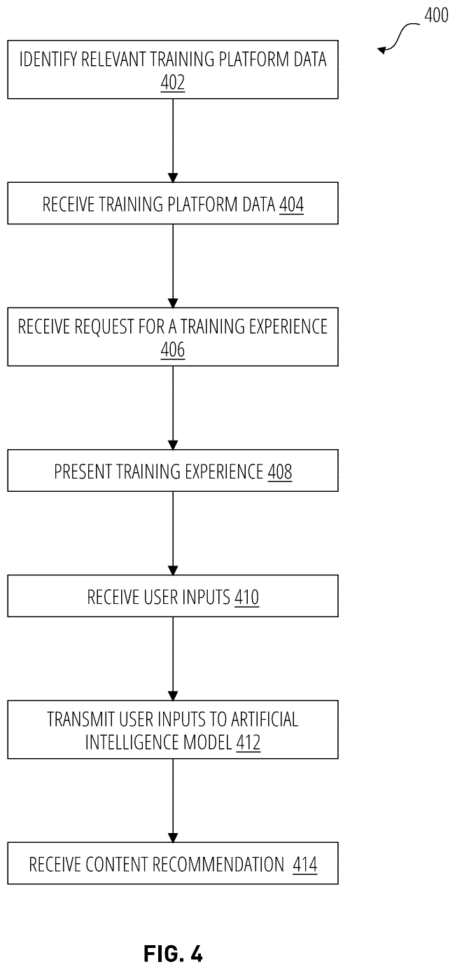

FIG. 4 illustrates an example method 400 for engaging a user with a training experience in a deployment environment, such as a deployment environment with low-bandwidth wide area network connectivity, via the training system 102. As described in method 400, the training system may present the training experience despite low-bandwidth connectivity of the wide area network 106. Additionally, even in a deployment environment where the connectivity of the wide area network 106 may be sufficiently high, the training system 102 may present the training experience (e.g., according to method 400) with faster performance by reducing communication via the wide area network 106 to reduce latency associated with communication via the wide area network 106.

At operation 402, the training system 102 identifies training platform data relevant to the training experience of the user based on a knowledge base. In some examples, the training system 102 may predict training content that the user is likely to engage with based on the user's progression through the training experience (e.g., a current state of the user in the training experience) and/or a user proficiency of the user related to a training concept or mixture of training concepts. The knowledge base may be a multidimensional graph including nodes representing training content and edges representing a relationship between the nodes, such as a relationship between training concepts represented in the nodes and/or a recommended progression of training content for the training experience.

Based on user profile information of the user, such as the user's training history, the training system 102 may determine a current state of the user's progression through the training experience. For example, the training system 102 may determine a most recent training content item that the user engaged with, an assessment of the user's proficiency with a training concept, and/or the like. Based on the current state of the user, the training system 102 may traverse the knowledge base to forecast one or more training content items that the training system 102 may present to the user as a part of the user's training experience. For example, where the current state of the user indicates that the user exhibits low proficiency with a particular training concept, the training system 102 may traverse the knowledge base to identify one or more nodes related to the particular training concept and the training system 102 may identify the training content items represented by the one or more nodes as training content items that the training system 102 may likely present to the user during the training experience. In another example, where the current state of the user indicates a particular training content item as a recent item that the user engaged with, the training system 102 may traverse the knowledge base to identify a node representing the particular training content item and one or more additional nodes located nearby in the multidimensional graph. The training system 102 may identify the training content items represented by the one or more nearby nodes as training content items that the training system 102 may likely present to the user during the training experience.

At operation 404, the training system 102 receives training platform data. The training system 102 may communicate with the content management system 112 and/or data store 114 via the wide area network 106 to retrieve training platform data relevant to the training experience of the user. Training platform data may include training content and user authentication and profile information. For example, training content may include multimedia files such as videos or text documents that the training system 102 identified that the user may engage with during the training experience. User authentication information may include unique tokens associated with users and login information. User profile information may include users' training history and content journey. In some examples, the training system 102 may be configured to retrieve training content based on a relationship of the training content to a user, a class of one or more users, a deployment environment, and/or a training experience. For example, to preserve the security of sensitive training content, the training system 102 may communicate with the content management system 112 to retrieve only a training content files that a user is authorized to access. The training system 102 may the training platform data in memory 120. For example, the training system 102 may store training content in media assets 122 and user authentication and profile information in user profile data 124. In this manner, the training system 102 may reduce the amount of data communicated via the wide area network 106 by retrieving only training platform data that the training system 102 has identified as relevant to the training experience of the user. As such, the training system 102 may reduce the latency associated with communication via the wide area network 106, such as where the wide area network 106 is limited to low-bandwidth connectivity.

In some examples, the training system 102 may perform operation 402 and operation 404 prior to moving to a deployment environment with low-bandwidth wide area network connectivity. For example, the training system 102 may receive a user input indicating an intent to move locations to the deployment environment with low-bandwidth wide area network connectivity. Based on the user input, the training system 102 may perform operation 402 to identify relevant training platform data and operation 404 to receive the training platform data prior to entering the deployment environment with low-bandwidth wide area network connectivity. In some examples, the training system may repeat operation 402 and operation 404 to update the training platform data stored in memory 120 at regular intervals, as the user progresses through the training experience, and/or the like.

At operation 406, the training system 102 receives a request for a training experience. The request may be received from a user device 108 across a local area network 104. The request may seek to initiate or continue a training experience for a specified user in a specified content or subject matter. For example, a user may submit a request from user device 108 to continue a job orientation training that the user had previously begun on a different device.

At operation 408, the training system 102 transmits a training experience to a user device and presents (or causes to be presented) the training experience at a user device 108. In some examples, the training system 102 may present training platform data stored in local memory 120 related to a user or training experience. For example, the training system 102 may communicate user authentication information from user profile data 124 to the user device 108 across a local area network 104 in order to authenticate login credentials input by the user. The training system 102 may also communicate multimedia files from media assets 122 to the user device 108 across a local area network 104, where the multimedia files are utilized as part of the user's training experience. The training system 102 may also communicate with remote artificial intelligence system 132 hosting remote artificial intelligence model 116 across a wide area network 106 to receive content recommendations generated by the remote artificial intelligence model 116. The training system 102 may then retrieve the content items recommended by the remote artificial intelligence model 116 from media assets 122 and present the retrieved content items to the user device 108 as a part of the training experience. For example, the remote artificial intelligence model 116 may recommend an additional training video based on a user's profile information. The training system may then retrieve the recommended video file from local storage in media assets 122 and present the additional video file to the user device 108. The training experience may be presented to the user through a user interface 110. At operation 410, the training system 102 receives user inputs in response to the training experience presented at the user device 108. The user inputs may include inputs received via the user interface 110, inputs collected via a sensor (e.g., eye-tracking sensor, head-motion sensor, etc.), and/or other inputs indicating an engagement of the user with the training experience. For example, a user may be presented with an assessment or quiz on a user device 108 as a part of the training experience. The user may select answers in response to the quiz, and the user selected answers may be communicated to the training system 102 as user inputs. Additionally, the user may interact with a confidence input (e.g., a slider) of the user interface 110 to indicate a confidence perceived by the user of the veracity of the answers selected by the user in response to the quiz. In some examples, user inputs may be received from a user on a user device 108, such as through a user interface 110, and communicated to the training system 102 across a local area network 104. The user inputs may be stored in user profile data 124 as a part of the user's training or content journey.

In some examples, the training system 102 may delete media assets 122 from memory 120 after a time threshold and/or after the media assets 122 have been presented to the user device 108. In one example, after a training content item has been presented to the user via the user interface 110 as a part of the training experience, the training system 102 may determine that the user has completed engagement with the training content item. For example, based on user input interacting with the training content item via the user interface 110, the training system 102 may determine that the user has finished viewing the entirety of the training content, responded to all questions presented to the user, and/or otherwise completed interaction with the training content item. The training system 102 may delete the training content item from memory 120 to maintain security protection for the training content item. In another example, the training system 102 may delete training content items stored in memory 120 forty-eight hours after the training content item is initially received and stored in memory 120. In this manner, the training system 102 may provide enhanced security for the media assets 122, such as media assets 122 that include sensitive and/or proprietary information, by reducing the time the media assets 122 are stored in memory 120.

At operation 412, the training system 102 transmits the user inputs received at operation 410 to the remote artificial intelligence system 132 hosting the remote artificial intelligence model 116. For example, where the user took a quiz, the training system 102 may transmit the user answers to the quiz and information regarding the quiz to the remote artificial intelligence system 132, that may then communicate the user answers and information regarding the quiz to the remote artificial intelligence model 116. The user inputs may be communicated to the remote artificial intelligence system 132 through a wide area network 106.

In some examples, the training system 102 may transmit the user inputs to the remote artificial intelligence system 132 to further train and/or fine-tune the remote artificial intelligence model 116. The user inputs may represent the user's engagement with the training experience. In one example, based on the user input, the training system 102 may generate metrics representing user proficiency related to a certain concept and the effect of certain media assets 122 on user proficiency related to the certain concept. For example, the training system 102 may determine an improvement in user proficiency related to a particular training content item by measuring an improvement from a user score for a quiz taken before engaging with the particular training content item compared to a user score for a quiz taken after engaging with the particular training content item. The training system 102 may generate a metric indicating the improvement in user proficiency related to the particular training content item. The training system 102 may transmit the user inputs and/or metrics to the remote artificial intelligence system 132, and the remote artificial intelligence system 132 may train and/or fine-tune the remote artificial intelligence model 116 based on the user inputs and/or metrics to improve the content recommendations and/or training content generated by the remote artificial intelligence model 116.

At operation 414, the training system 102 communicates with the remote artificial intelligence system 132 to receive content recommendations from the remote artificial intelligence model 116. In some examples, the content recommendations may be responsive to an analysis conducted by the remote artificial intelligence model 116 of the user inputs transmitted at operation 412. The remote artificial intelligence model 132 may generate the content recommendations based on the user inputs and knowledge base. For example, if the user inputs represent a user's answers to a quiz, and the remote artificial intelligence model 116 determines that a user's answers display unfamiliarity, misunderstanding, lack of skill, and/or comprehension for a concept and/or particular training subject matter, the remote artificial intelligence model 116 may generate content recommendations for the particular subject matter and communicate the recommendations to the training system 102. In another example, where a user's answer demonstrates high accuracy, skill, competency and/or comprehension for a specific concept or combination of concepts, the remote artificial intelligence model 116 may generate content recommendations configured to accelerate the user's progression past the specific concept or highly similar concepts in the knowledge base and into more difficult concepts that are related to the specific concept or are new concepts for the user. The training system 102 may define the difficulty of the concepts based on the configuration of the concepts within the knowledge base, and/or based on aggregate data of multiple users, and/or specific user groups, interacting with the training content represented in the knowledge base. In some examples, the content recommendations are restricted to content items which are stored in media assets 122 or otherwise available in local memory 120. The training system 102 may receive the content recommendations through communication with the remote artificial intelligence system 132 hosting the remote artificial intelligence model 116 across a wide area network 106.

In response to receiving the content recommendations from the remote artificial intelligence model 116, the training system 102 may retrieve the corresponding content items from media assets 122 or from other storage locations in local memory 120 and present the content items to the user as part of the user's training experience by communicating the content items to the user device 108 across a local area network 104. The content items may be presented to the user through a user interface 110.

In some examples, the training system 102 may update the weights of the knowledge base and/or weights of the remote artificial intelligence model 116 based on the aggregate data of multiple users interacting with the training content represented in the knowledge base. For example, if data of multiple users related to a certain content item indicates a usefulness (e.g., based on ratings of the certain content item, or an assessment on the effect of the certain content item on user understanding for a concept), an engagement level (e.g., based on the time spent by the multiple users engaging with the training content), a difficulty (e.g., based on an assessment of accuracy, confidence, and time to respond of user inputs responding to the certain content item), the training system 102 may alter the weighted edges in the knowledge base related to the certain content item. In this manner, the training system 102 may optimize the content recommendations generated for the user. In some examples, the training system 102 may account for viewing biases (e.g., biases in ratings based on a number of views) when altering the weights of the knowledge base and/or remote artificial intelligence model.

FIG. 5 illustrates an example method 500 for engaging a user with a training experience in intermittent wide area network connectivity, such as by using the training system 202, in accordance with an embodiment of the disclosure. At operation 502, the training system 202 receives training platform data and a remote artificial intelligence model 116. Training platform data may include training content and user authentication and profile information. For example, training content may include multimedia files such as videos or text documents suitable for inclusion in a user's training experience. In another example, the training content may include the knowledge base. For example, the knowledge base may include a multidimensional graph including nodes representing the multimedia files and weighted edges representing the probability that one or more multimedia files present training content related to the same and/or similar concept or mixture of concepts.

User authentication information may include unique tokens associated with users and login information. User profile information may include users' training history and content journey. In some examples, the training system 202 may anonymize and/or pseudonymize user information that may include personally identifiable information of the user. The training system 202 may receive the training platform data through communication with the content management system 112 or data store 114 via a wide area network 206 during periods when connectivity is available. In some examples, the training system 202 may be configured to retrieve training content related to a user, a class of one or more users, a deployment environment, and/or a training experience. For example, to preserve the security of training content, the training system 202 may communicate with the content management system 112 to retrieve only a portion of a knowledge base and associated multimedia files that is authorized for the deployment environment.

In some examples, the training system 202 may retrieve training content based on the knowledge base. For example, based on a user proficiency related to a training content or concept, the training system 202 may traverse the knowledge base to determine training content relevant to the user, such as training content related to a concept with low user proficiency, training content that was assessed to contribute to an increase in user proficiency for a concept (e.g., based on individual data of the user and/or aggregate data of multiple users), training content related to a lesson plan of a training experience, and/or the like. In another example, the training system 202 may traverse the knowledge base based on aggregate data of multiple users interacting with the training content represented in the knowledge base. The training system 202 may communicate with the content management system 112 and/or data store 114 to retrieve the training content relevant to the user.

The remote artificial intelligence model 116 may be configured to generate training content and/or content recommendations responsive to the user's engagement with the training experience. The training system 202 may receive the remote artificial intelligence model 116 through communication with the remote artificial intelligence system 132 hosting the remote artificial intelligence model 116 across a wide area network 206 during periods when connectivity is available.

At operation 504, the training system 202 stores the training platform data and the remote artificial intelligence model 116 into local storage, where a copy of the remote artificial intelligence model 116 may be stored in the local artificial intelligence model 228. The training content may be stored in media assets 222, the user authentication and profile information may be stored in user profile data 224, and the remote artificial intelligence model 116 may be stored in local artificial intelligence model 228.

At operation 506, the training system 202 receives a request for a training experience. The training system 202 may communicate with a user device 108 (e.g., via the local area network 104) to receive the request. The request may seek to initiate or continue a training experience for a specified user in a specified content or subject matter. For example, a user may submit a request from user device 108 to continue a job orientation training that the user had previously begun on a different device. In some examples, the training system 202 may receive the request only from an authorized user device 108 or an authorized user. The training system 202 may be configured to restrict communication with user devices 108 and/or users that are not authorized.

At operation 508, the training system 202 transmits a training experience to a user device and presents (or causes to be presented) the training experience at the user device 108. In some examples, the training system 202 may present training platform data stored in local memory 220 related to a user or training experience. For example, the training system 202 may communicate user authentication information from user profile data 224 to the user device 108 across a local area network 104 in order to authenticate login credentials input by the user. The training system 202 may also communicate multimedia files from media assets 222 to the user device 108 across a local area network 104, where the multimedia files are utilized as part of the user's training experience. The local artificial intelligence model 228 may also generate training content recommendations based on the user profile information and available media assets 222. The training system 202 may then retrieve the content items recommended by the model from media assets 222 and present the retrieved content items to the user device 108 as a part of the training experience. For example, the local artificial intelligence model 228 may recommend an additional training video based on a user's profile information. In some cases, the artificial intelligence model 228 may recommend a specific portion of the additional training video based on the concepts represented by any combination of the images and language contained in the frames of the video and user profile data 224 of the user. The training system may then retrieve the recommended video file from local storage in media assets 222 and communicate the additional video file to the user device 108. The training experience may be presented to the user through a user interface 110. In some examples, the training system 202 may assess a confidence of each recommended content item, which may be expressed as a percentage, that may represent a probabilistic assessment of the utility of the recommended content items relative the user and/or a veracity of the recommended content items. The training system 202 may communicate the confidence to the user device 108 and configure the user device 108 to display the confidence in conjunction with the recommended content item. In this manner, the training system 202 may enable the user to make an informed judgement on the information presented by the recommended content item.

At operation 510, the training system 202 receives user inputs in response to the training experience presented at the user device 108. For example, a user may be presented with an assessment or quiz on a user device 108 as a part of a training experience. The user may select answers in response to the quiz, and the user selected answers may be communicated to the training system 202 as user inputs.

In some examples, user inputs may be received from a user on a user device 108, such as through a user interface 110, and communicated to the training system 102 across a local area network 104. The user inputs may be stored in user profile data 124 as a part of the user's training journey.

In some examples, the training system 202 may delete media assets 222 (or other content) from memory 220 after a time threshold and/or after the media assets 222 have been presented to the user device 108. For example, after training content has been presented to the user via the user interface 110 as a part of the training experience and the user has completed interacting with the training content, the training system 202 may delete the training content from the memory 220 to maintain security protection for the training content.

At operation 512, the training system records the user inputs and system outputs in the input/output log 230. For example, where the user took a quiz, the training system 202 may store the user inputs, such as the user's answers to the quiz in the input/output log 230. The training system 202 may also store system outputs, such as quiz questions or system responses output to the user in the input/output log 230.

At operation 514, the training system 202 uses the recorded user inputs and system outputs to re-simulate the user training journey with remote computing systems. In some examples, the user training journey is deterministic, that is, system outputs are determinable given user inputs. During periods of available connectivity through the wide area network 206, the training system 202 may connect with remote computing systems such as the content management system 112, data store 114, and remote artificial intelligence system 132 hosting the remote artificial intelligence model 116 though the wide area network 206 and communicate the user inputs and system outputs stored in the input/output log 230 to the remote computing systems to re-simulate the user training journey. The re-simulated user training journey may be utilized by the remote artificial intelligence system 132 to update the remote artificial intelligence model 116 with training data based on the re-simulated user inputs. For example, the remote artificial intelligence system 132 may further train and/or fine-tune the remote artificial intelligence model 116 based on the re-simulated user training journey to improve the performance of the remote artificial intelligence model 116 in generating training content and/or content recommendations. The re-simulated user training data may also be used to update data store 114 with user profile data, such as the user's proficiency with certain training topics or content.

For example, the training system 202 may re-simulate the user training journey by communicating the user inputs in chronological order to the remote artificial intelligence system 132 hosting the remote artificial intelligence model 116 to simulate the order of inputs received from the user. The remote artificial intelligence model 116 may utilize the user inputs and re-simulated user training journey to update the remote artificial intelligence model 116 or training data set. The training system 202 may additionally communicate the user inputs and/or user training journey to the content management system 112 or data store 114 through a wide area network 206 to update the user profile information. For example, the training system 202 may communicate with the data store 114 to update user profile information regarding the training courses completed by the user.

In some examples, the training system 202 may re-simulate the user training journey to update the knowledge base. In one example, where the knowledge base represents an expected progression of the user through the training experience, the training system 202 may re-simulate the user training journey to update the knowledge base based on the actual progression of the user through the training experience. For example, the nodes of the knowledge base may be connected by weighted, directed edges representing a probability of progression from a node to a next node.

The training system 202 may re-simulate the user training journey to update the weights of the directed edges based on the actual progression of the user through nodes of the knowledge base. In another example, where the weighted edges of the knowledge base represent a relationship between training concepts represented by corresponding nodes, the training system 202 may re-simulate the user training journey to update the weights of the edges to update the relationship between nodes. For example, where re-simulation indicates that the user's progression through a first node and a second node greatly increased the user's proficiency in a particular training concept, the training system 202 may update the knowledge base to increase the weight of the edge connecting the first node and the second node to indicate a greater relationship between the first node and the second node relative to the particular training concept.

At operation 516, the training system 202 receives and updates local memory 220 with any new content or data from content management system 112, data store 114, remote artificial intelligence system 132, and/or remote artificial intelligence model 116 during periods where connection is available through a wide area network 206. The training system 102 may receive new training content available through the content management system 112 or data store 114. The training system 102 may also update the local artificial intelligence model 228 to reflect any changes or updates to the remote artificial intelligence model 116. Such new or updated content may be stored locally in memory 220 and utilized by training module 226 during periods when wide area network connectivity is unavailable.

For example, training system 202 may communicate with content management system 112 through a wide area network 206 to receive new training programs and store the new programs in media assets 222. Training system 202 may also communicate with data store 114 through a wide area network 206 to receive any new training content, such as new multimedia files, and store the new content in media assets 222. Training system 202 may also communicate with the remote artificial intelligence system 132 through a wide area network 206 to receive updates or changes with the remote artificial intelligence model 116 and incorporate the updates into the local artificial intelligence model 228.

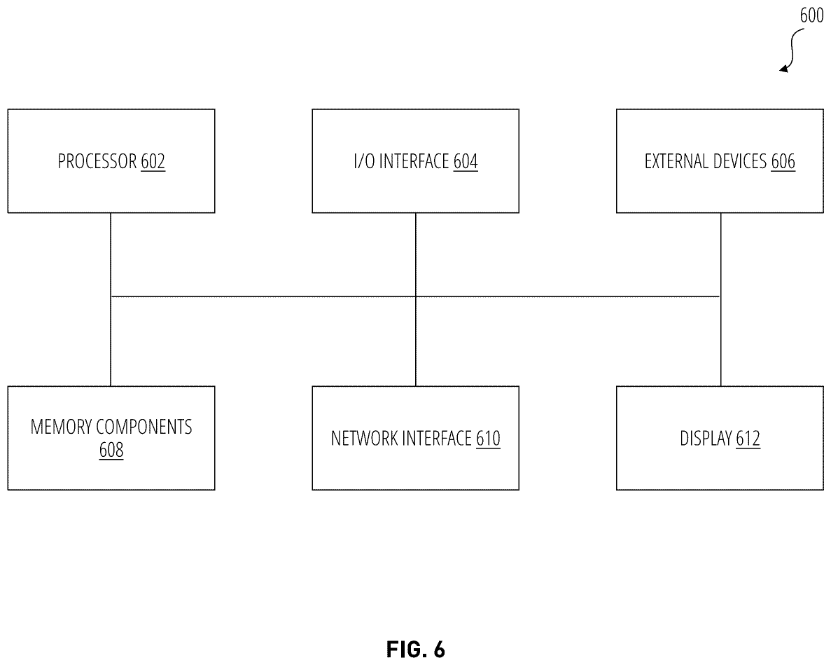

FIG. 6 illustrates a block diagram of an example computer system 600 suitable for use in embodiments disclosed herein in accordance with an embodiment of the disclosure. For example, processors 118 and 218 and memories 120 and 220 may be located at one or several computing systems 600. In various embodiments, user device 108 is also implemented by a computing system 600. This disclosure contemplates any suitable number of computing systems 600. For example, the computing system 600 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 600 may include one or more computing systems; be unitary or distributed; span multiple locations; span multiple machines; span multiple data centers; or reside in a cloud, that may include one or more cloud components in one or more networks. The computing system 600 may include one or more processors 602, an input/output (I/O) interface 604, one or more external devices 606, one or more memory components 608, and a network interface 610. Each of the various components may be in communication with one another through one or more buses or communication networks, such as wired or wireless networks.

The processor 602 may be any type of electronic device capable of processing, receiving, and/or transmitting instructions. For example, the processor 602 may be a central processing unit, microprocessor, processor, or microcontroller. Additionally, it should be noted that some components of the computing system 600 may be controlled by a first processor and other components may be controlled by a second processor, where the first and second processors may or may not be in communication with each other.

The I/O interface 604 allows a user to enter data in to computing system 600, as well as provides an input/output for the computing system 600 to communicate with other devices or services. The I/O interface 604 can include one or more input buttons, touch pads, and so on.

The external devices 606 are one or more devices that can be used to provide various inputs to the computing device 600, e.g., mouse, microphone, keyboard, trackpad, or the like. The external devices 606 may be local or remote and may vary as desired. In some examples, the external devices 606 may also include one or more additional sensors.

The memory components 608 are used by the computing system 600 to store instructions for the processing element 602, as well as store data, such as store data 120 (FIG. 1) and the like. The memory components 608 may be, for example, magneto-optical storage, read-only memory, random access memory, erasable programmable memory, flash memory, or a combination of one or more types of memory components.

The network interface 610 provides communication to and from the computing system 600 to other devices. The network interface 610 includes one or more communication protocols, such as, but not limited to WI-FI®, Ethernet, BLUETOOTH®, and so on. The network interface 610 may also include one or more hardwired components, such as a Universal Serial Bus (USB) cable, or the like. The configuration of the network interface 610 depends on the types of communication desired and may be modified to communicate via WI-FI®, BLUETOOTH®, and so on.

The display 612 provides a visual output for the computing devices and may be varied as needed based on the device. The display 612 may be configured to provide visual feedback to the user and may include a liquid crystal display screen, light emitting diode screen, plasma screen, or the like. In some examples, the display 612 may be configured to act as an input element for the user through touch feedback or the like.

The components in FIG. 6 are exemplary only. In various examples, the computing system 600 may include additional components and/or functionality not shown in FIG. 6.

Accordingly, the training systems 102 and 202 described herein addresses particular challenges and needs presented by training and learning systems. For example, training systems often utilize wide area network connections, and traditional training systems may not adequately function where the network connectivity is low or intermittent, especially where media assets or artificial intelligence models utilized by the training system are memory intensive and infeasible for storage on user devices. The training systems 102 and 202 may communicate with content management systems, data stores, and remote artificial intelligence models during available wide area network connectivity, generate training experiences, and present the training experiences to user devices across a local area network. The training system may also record the user training journey and re-simulate the training journey with the remote artificial intelligence model during available wide area network connectivity. The training systems 102 and 202 accordingly provides for an improved training process, allowing for the generation and service of training experiences during low or intermittent wide area network connectivity or no connectivity of parts of the system because of security restrictions.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The description of certain embodiments included herein is merely exemplary in nature and is in no way intended to limit the scope of the disclosure or its applications or uses. In the included detailed description of embodiments of the present systems and methods, reference is made to the accompanying figures which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description therefore is not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

Although the methods described herein (e.g., method 200) depict a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the figures and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods. The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A computer-implemented method for presenting a training experience, comprising:
identifying, via a processor, training content relevant to the training experience based on a knowledge base;
storing, via the processor, the training content and a local artificial intelligence model into a local storage on a computer device in a deployment environment;
transmitting, via the processor, the training content to a user device for display via a user interface;
receiving, via the processor, user inputs based on the training content;
re-simulating, via the processor, a remote computing system using the user inputs during a first connectivity state, wherein re-simulating the remote computing system comprises re-simulating the training experience based on the user inputs to update the knowledge base representing an expected training experience; and
updating, via the processor, the local storage with updated training content during a second connectivity state, the updated training content produced by the remote computing system during the re-simulation.

2. The method of claim 1, wherein:
the first connectivity state is a first period of wide area network connectivity; and
the second connectivity state a distinct second period of wide area network connectivity.

3. The method of claim 1, wherein transmitting the training content comprises:
generating, via the processor, the training experience based on the training content and the local artificial intelligence model; and
transmitting, via the processor, the training experience to the user device.

4. The method of claim 1, wherein the local storage comprises:
a low security local storage accessible via a local area network and a global wide area network; and
a high security local storage only accessible via a local area network.

5. The method of claim 4, wherein storing training content and a local artificial intelligence model into a local storage comprises:
categorizing, via the processor, the training content into high security training content and low security training content;
storing, via the processor, the high security training content in the high security local storage; and
storing, via the processor, the low security training content in the low security local storage.

6. The method of claim 1, wherein transmitting the training content and receiving user inputs comprises communicating with the user device via a local area network.

7. The method of claim 1, wherein identifying the training content comprises identifying, via the processor, a plurality of nodes of the knowledge space representing a plurality of training content related to a mixture of training concepts that make up a training subject.

8. The method of claim 1, wherein the remote computing system comprises a remote artificial intelligence model, and wherein updating the local storage further comprises updating, via the processor, the local artificial intelligence model based on the remote artificial intelligence model of the remote computing system.

9. The method of claim 1, further comprising:
receiving, via the processor, aggregate data of multiple users representing interactions of the multiple users with the training content; and
updating, via the processor, a knowledge base representation of the training content based on the aggregate data.

10. A computer-implemented method for deploying a training platform comprising:
receiving, via a processor of a computing device, a request to engage with the training platform;
identifying, via the processor, training platform data relevant to a training experience based on a knowledge base;
retrieving, via the processor, the training platform data and a local artificial intelligence model of the training platform from a local storage in communication with the computing device;
outputting, via the processor, a user interface configured to display the training experience based on the training platform data and local artificial intelligence model;
receiving, via the processor, user engagement data based on user interaction with the training experience, the user engagement data including a training journey and user inputs;
storing, via the processor, the user engagement data in the local storage; and
transmitting, via the processor, the user engagement data to a remote computing system to enable the remote computing system to re-simulate the user interaction and to generate updated user profile data for the training platform.

11. The method of claim 10, wherein the training platform data comprises training content files and user profile information.

12. The method of claim 10, wherein the user request is received through communication with a user device across a local area network.

13. The method of claim 10, wherein outputting the user interface comprises:
generating, via the processor, the training experience based on the training platform data and the local artificial intelligence model;
generating, via the processor, the user interface configured to display the training experience; and
causing display, via the processor, the user interface at the user device.

14. The method of claim 13, wherein transmitting the training experience and receiving the user inputs comprises communicating with a user device across a local area network.

15. The method of claim 10, wherein the updated user profile data comprises the user training journey and an evaluation of the user engagement generated by the remote computing system.

16. A computer-implemented method for presenting training content, comprising:
identifying, via a processor, training platform data relevant to a training experience based on a knowledge base;
storing, via the processor, the training platform data into local storage on a computer device;
transmitting, via the processor, training content to a user device for display via a user interface;
receiving, via the processor, user inputs in response to the training content;
communicating, via the processor, the user inputs to a remote artificial intelligence model via a wide area network connection; and
receiving, via the processor, content selections from the remote artificial intelligence model.

17. The method of claim 16, further comprising:
retrieving, via the processor, training content items from the training platform data in the local storage based on the content selections; and
transmitting, via the processor, the training content items to the user device.

18. The method of claim 16, wherein the training platform data comprises training content files and user profile information.

19. The method of claim 16, wherein transmitting training content comprises:
generating, via the processor, the training experience from the training platform data and through communication with the remote artificial intelligence model via the wide area network connection; and
transmitting, via the processor, the training experience to the user device.

20. The method of claim 16, wherein transmitting the training content and receiving the user inputs comprises communicating with a user device across a local area network.
